(19) United States
(12) Patent Application Publication
(10) Pub. No.: US 2007/0283406 A1
(43) Pub. Date: Dec. 6, 2007

(54) Twisted pair to coax adapter for network interface device

(76) Inventors: Kathleen E. Blake, Keller, TX (US); Christian S. Duran, Ft. Worth, TX (US); Robert J. Bennett, Allen, TX (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/444,253

(22) Filed: May 31, 2006

(51) Int. Cl. H04N 7/16; H04N 7/173; H04N 7/18

(52) U.S. Cl. 725/127; 725/80; 725/149

(57) ABSTRACT

An apparatus and method is provided for permitting a service provider technician or subscriber to install a twisted wire pair to coax adapter within a network interface device (NID) at a subscriber premises. The twisted wire pair to coax adapter is configured for snap-in mounting within a NID. The adapter includes input and output connections, as well as an internally disposed balun, and is configured to convert communications signals carried on a twisted wire pair to communications signals carried on a coax cable to avoid degradation of the signals resulting from the use of an unshielded twisted wire pair within a subscriber premises.

### FIELD OF THE INVENTION

The present invention relates generally to adapters for use at subscriber premises. More particularly, the present invention relates to an adapter for a network interface device (NID) that provides twisted wire pair to coaxial cable conversion.

### BACKGROUND OF THE INVENTION

Presently, telephone companies provide plain old telephone service (POTS) and high speed data communications services to subscribers. Recently, however, the same telephone companies have expressed a desire to deploy video services to their subscribers over the existing telephone company owned network.

The telephone company network typically consists of fiber optic and copper communications distribution cables with a copper twisted wire pair or “drop” cable leading to the subscriber premises. The drop cable is usually connected to the subscriber premises wiring by way of a network interface device (NID). In most cases, an unshielded twisted pair of copper wires is used within the subscriber premises to provide continuity to telephone jacks and high speed data jacks. Video service, however, requires more bandwidth than utilized by POTS and/or data services.

Defects in the twisted pair copper wires as well as inherent characteristics of the unshielded wiring used within a subscriber premises including, but not limited to, crosstalk, insertion loss, and electromagnetic interference (EMI) can degrade the quality of the video service. Shielded coaxial cable is less vulnerable to these defects than twisted pair copper wires and is, therefore, a more suitable transmission medium for higher frequency applications. Given the improved capabilities of coaxial cable over twisted pair copper wires, some telephone companies have expressed a desire to deploy the video services through coaxial cable wiring within the subscriber premises instead of twisted pair wiring.

Twisted wire pair to coax baluns, as illustrated in FIG. 3, have previously been provided to convert communications signals carried on twisted pair wiring to communications signals carried on coaxial cable. These previously known devices 300 were designed to be mounted outside a NID or inside a subscriber premises. The previously known twisted wire pair to coax balun devices 300 generally comprise a pair of twisted wire input lines 302 passing through an opening in a housing 304 for connection to an input of a balun (not visible) contained within the housing 304. The pair of twisted wire input lines 302 may be coupled to the balun via a connector (not shown) or by direct connection to the input of the balun. A coax connector 308 is mounted to one end of the housing 304. Coax connector 308 is electrically coupled to an output of the balun. A coax cable with a compatible connector attached to one end may be connected to connector 308 for transmission of video signals into a subscriber premises. Housing 304 may also include a grounding terminal 306 for coupling the housing to earth ground.

With the recent desire of telephone companies to provide video service to subscribers, it may be more desirable to place the twisted wire pair to coax balun inside the telephone company owned NID. Thus, it would be desirable to provide a twisted wire pair to coax balun that is conveniently mounted within a NID. Moreover, it would be further desirable to provide a twisted wire pair to coax balun that may be installed by a subscriber, thereby avoiding the expense of requiring a service technician from the telephone company to travel to the subscriber premises.

While various implementations of twisted wire pair to coax balun adapters have been developed, no design has emerged that generally encompasses all of the desired characteristics as hereafter presented in accordance with the present invention.

### SUMMARY OF THE INVENTION

In view of the deficiencies recognized in the prior art and addressed by the present invention, an improved apparatus and method for installing a twisted wire pair to coax balun adapter at a subscriber premises is provided.

In an exemplary embodiment, an adapter is provided that enables a subscriber to install a twisted wire pair to coax balun without requiring the service provider to dispatch a trained service technician to the subscriber premises.

In another exemplary embodiment, a twisted wire pair to coax adapter is provided for mounting in a network interface device (NID) commonly utilized at a subscriber premises.

A desirable aspect of an adapter according to the present invention is the protection from adverse environmental conditions provided to the adapter and its electrical connections due to mounting within a NID.

Additional objects and advantages of the present invention are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the invention. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present invention may include various combinations or configurations of presently disclosed features, steps, or elements, or their equivalents including combinations of features, parts, or steps or configurations thereof not expressly shown in the figures or stated in the detailed description of such figures. Additional embodiments of the present invention, not necessarily expressed in the summarized section, may include and incorporate various combinations of aspects of features, components, or steps referenced in the summarized objects above, and/or other features, components, or steps as otherwise discussed in this application.

It should be appreciated that while the present disclosure is directed in some aspects to installation of a twisted wire pair to coax balun adapter by a subscriber, such is not a requirement of the present invention. As will be evident to those of ordinary skill in the art, the presently disclosed apparatus and methods may also be used and applied by other than subscribers including a trained service technician as well as a service technician having less training than those typically dispatched by the service provider to install twisted wire pair to coax balun adapters.

It should further be appreciated that while the description of the present invention is directed in some aspects to a twisted wire pair to coax balun adapter configured for installation at a private residence, such is also not a limitation of the present invention as such equipment may also be installed at locations other than a private residence, including, for example, multi-dwelling buildings and small business locations. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which makes reference to the appended figures in which:

FIG. 1(a) is a side view of a twisted wire pair to coax balun adapter in accordance with a first embodiment of the present invention;

FIG. 1(b) is a side view of a twisted wire pair to coax balun adapter in accordance with a second embodiment of the present invention;

FIG. 2 illustrates an exemplary installation of a twisted wire pair to coax balun adapter in accordance with the present invention mounted within a residential network interface device (NID); and

FIG. 3 illustrates a prior art twisted wire pair to coax balun.

Repeat use of reference characters throughout the present specification and appended drawings is intended to represent same or analogous features or elements of the invention.

### DETAILED DESCRIPTION OF PREFERRED EMBODIMENTS OF THE INVENTION

As discussed above, the present invention provides apparatus and methods for installing a twisted wire pair to coax balun adapter at a subscriber premise, with or without assistance from a trained service technician.

Selected combinations of aspects of the disclosed technology correspond to a plurality of different embodiments of the present invention. It should be noted that each of the exemplary preferred embodiments presented and discussed herein are not intended to limit the desired scope of the invention. Features or steps illustrated or described as part of one embodiment may be used in combination with aspects of another embodiment to yield yet further embodiments. Additionally, certain features may be interchanged with similar devices or features not expressly mentioned which perform the same or similar function.

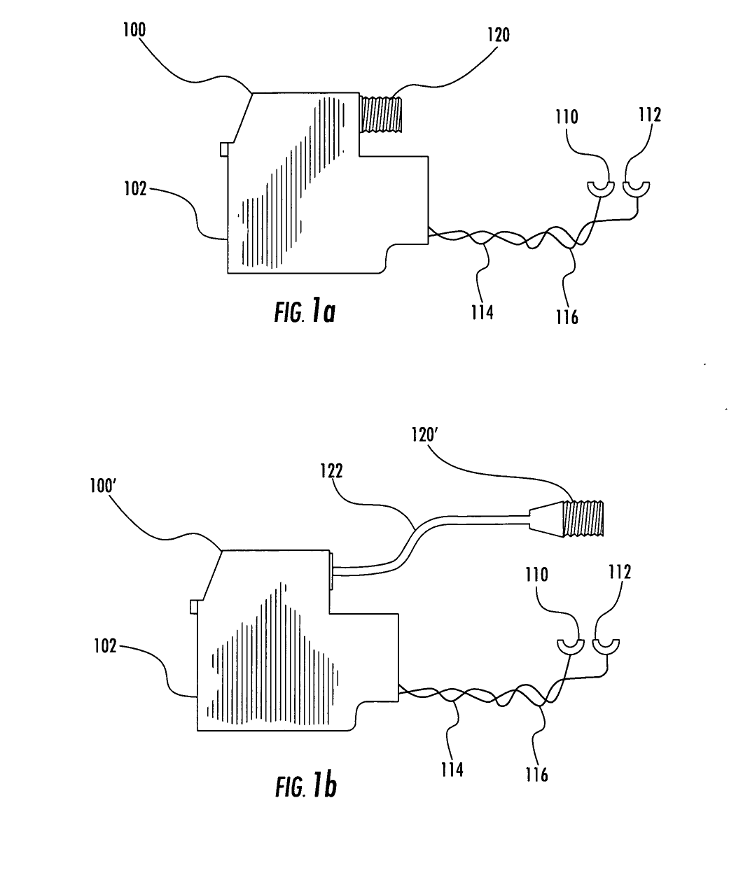

Reference will now be made in detail to presently preferred embodiments of a twisted wire pair to coax balun adapter. Referring now to the drawings, FIG. 1(a) is a side elevation view of a twisted wire pair to coax adapter 100 in accordance with a first embodiment of the present invention. In one embodiment, the adapter 100 may be provided to a subscriber as a part of a kit for self-installation of a twisted wire pair to coax adapter at a subscriber premises for transmitting video communications services from a service provider, such as a telephone company.

The twisted wire pair to coax adapter 100 comprises a housing 102 which is designed to contain a twisted wire pair to coax balun (not visible) and to support input and output connections configured to provide signal coupling between a drop cable provided by the service provider and a shielded coaxial cable deployed within a subscriber premises. The input connection may correspond to twisted pair wires 114, 116 passing through an appropriately sized access hole in housing 102 and coupled at first ends to a pair of spade connectors 110, 112 for connection to conventional screw terminals (not shown). The second end of each of the twisted pair wires is electrically coupled to an input of the balun disposed within the housing 102. In an alternate embodiment, a pair of conventional screw terminals or other appropriately configured connector may be mounted to the exterior surface of housing 102 for electrically coupling a twisted wire pair from a service provider drop cable to the balun.

A coax connector 120 may be coupled to an exterior portion of housing 102 as illustrated in FIG. 1 with an electrical connection portion thereof extending inside of the housing. The internal portion of coax connector 120 may be connected to an output of the balun disposed within the housing 102 and a compatible coax connector may be coupled to the exterior portion of the coax connector 120.

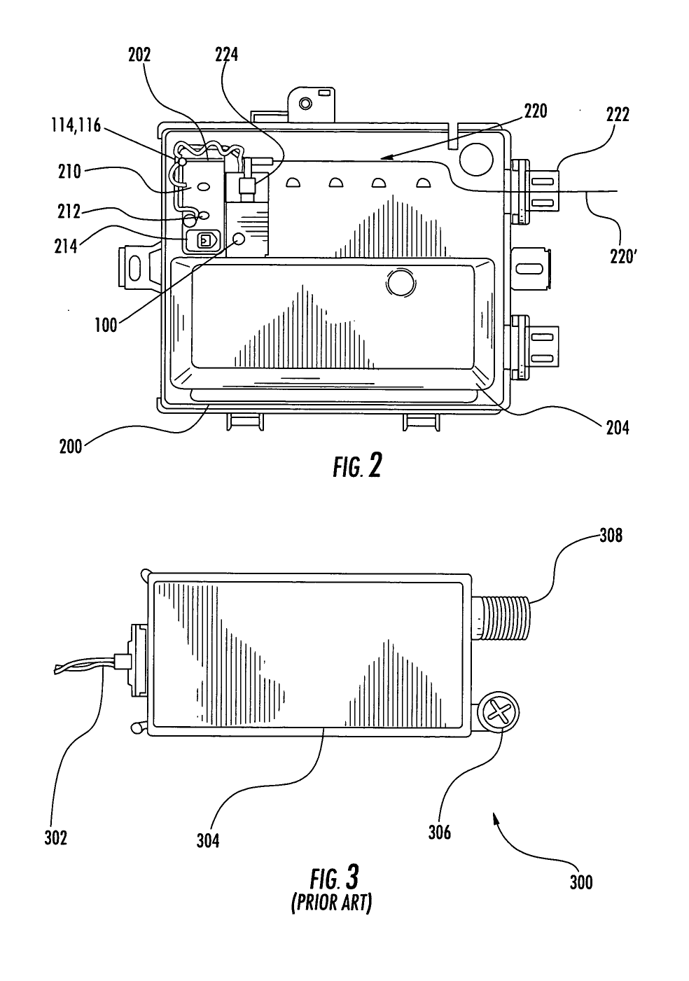

Housing 102 is configured for snap-in mounting in a subscriber accessible compartment within a NID as discussed later with respect to FIG. 2. In an exemplary configuration, the twisted wire pair to coax adapter 100 configured for a NID comprises a housing design that incorporates a footprint similar to a known single line module (SLM) Adjunct Line Splitter available from Corning Cable Systems LLC of Hickory, N.C. The SLM Adjunct Line Splitter footprint is advantageous in that such footprint allows the twisted wire pair to coax adapter 100 to be mounted in various NIDs, including NIDs provided by different manufacturers. It should be appreciated by those of ordinary skill in the art, however, that the use of a housing footprint is not required by the present invention.

With reference now to FIG. 1(b), a second exemplary embodiment of a twisted wire pair to coax adapter in accordance with the present invention is illustrated. Adapter 100′ is identical in every respect to adapter 100 illustrated in FIG. 1(a) except for coax connector 120. As illustrated in FIG. 1(b), a coax connector 120′ may be physically and electrically coupled to one end of a flexible coaxial cable 122, while the other end of flexible coaxial cable 122 passes though an appropriately sized access hole in housing 102 for electrical coupling to an output of the balun disposed within the housing 102. The provision of coax connector 120′ at the end of a flexible coaxial cable 122 may provide opportunity for easier coupling of an external coax connector to the coax connector 120′ in certain installations.

Referring now to FIG. 2, there is illustrated an exemplary installation of a twisted wire pair to coax adapter 100 in accordance with the present invention in a NID 200 at a subscriber premises, such as a private residence. As will be evident to one of ordinary skill in the art from the exemplary embodiment of the present invention illustrated in FIG. 2, a NID 200 at a private residence may be provided with a line module 202 having at least a pair of screw terminals 210, 212 for connecting subscriber wiring to selected circuitry contained within line module 202. Line module 202 may also be provided with a line jack 214. In an exemplary configuration, line jack 214 may correspond to an RJ-11 jack compatible with an RJ-11 plug, although the use of such particular type is not a limitation of the present invention.

In some embodiments of the present invention, line jack 214 and/or screw terminals 210, 212, as well as the selected circuitry contained within line module 202 may be combined with the balun circuitry contained within twisted wire pair to coax adapter 100. With further reference to FIG. 2, it may be observed that twisted wire pair to coax adapter 100 may be installed in a subscriber accessible compartment within NID 200 by snapping the adapter into place beside line module 202, or alternatively, in place of the line module 202 if adapter 100 also provides the functionality of line module 202. The adapter 100 may be installed in NID 200 without opening a service provider compartment 204, to which access is generally denied to the subscriber. The twisted wire pair to coax adapter 100 is protected by housing 200 from exposure to potentially adverse environmental conditions. The twisted wire pair to coax adapter 100 may also be encapsulated for environmental protection, while providing fixed connection points for both the twisted wire pair connection and the coax connector 120, which connections are also environmentally protected by virtue of mounting the housing 102 within the NID 200. As illustrated in FIG. 2, a flexible coax cable 220 may be coupled by way of a connector 224 that is compatible with coax connector 120 on adapter 100 at one end with a remote end 220′ of the coax cable passing through an access port 222 of the NID 200 for connection to subscriber premises wiring.

Housing 102 of twisted wire pair to coax adapter 100 may be constructed of any suitable material including, but not limited to, metals and plastics. Housing 102 may also be grounded for EMI shielding. If made of plastic, grounding may be provided by coating either or both of the interior or exterior of the housing with a conductive material.

The balun disposed within housing 102 and coupled between the input and output connections may correspond to various designs, any of which, presently known or yet to be developed, may be employed without departing from the spirit and scope of the present invention. In addition to the possible inclusion of line module components as previously noted, a digital subscriber line (DSL) splitter may be incorporated into housing 102 along with or in place of the line module components.

While the present invention has been described in detail with respect to specific embodiments thereof, it will be appreciated that those skilled in the art, upon attaining an understanding of the foregoing may readily produce alterations to, variations of, and equivalents to such embodiments. Accordingly, the scope of the present invention is by way of example rather than by way of limitation, and the present invention does not preclude inclusion of such modifications, variations and/or additions as would be readily apparent to one of ordinary skill in the art.

What is claimed is:

1. A twisted wire pair to coax adapter, comprising:
a housing configured for mounting in a network interface device (NID);
a balun mounted within said housing;
a twisted wire pair extending outside said housing and coupled at first ends thereof to an input of said balun; and
a coax connector electrically coupled to an output of said balun.

2. An adapter as in claim 1, wherein the coax connector is mounted to a surface of said housing.

3. An adapter as in claim 1, further comprising a flexible coaxial cable extending from said housing and having a first end thereof coupled to said output of said balun, said coax connector being electrically coupled to a second end of said flexible coaxial cable.

4. An adapter as in claim 1, further comprising a pair of spade connectors coupled to second ends of said twisted wire pair and configured for connecting to conventional screw terminals.

5. An adapter as in claim 3, further comprising a pair of spade connectors coupled to second ends of said twisted wire pair and configured for connecting to conventional screw terminals.

6. A network interface device, comprising:
a housing including a service provider compartment and a subscriber accessible compartment, the subscriber accessible compartment being configured for mounting a plurality of line modules in a plurality of positions;
a line module mounted in a first of the plurality of positions within the subscriber accessible compartment; and
a twisted wire pair to coax adapter mounted in a second of the plurality of positions within the subscriber accessible compartment, the twisted wire pair to coax adapter comprising:
an adapter housing configured for mounting in said subscriber accessible compartment;
a balun disposed within said adapter housing;
a twisted wire pair extending outside said adapter housing and electrically coupled at first ends thereof to an input of said balun; and
a coax connector electrically coupled to an output of said balun.

7. A network interface device as in claim 6, wherein the coax connector is mounted to a surface of said adapter housing.

8. A network interface device as in claim 6, further comprising a flexible coaxial cable extending from said adapter housing and having a first end thereof coupled to said output of said balun, said coax connector being electrically coupled to a second end of said flexible coaxial cable.

9. A network interface device as in claim 6, further comprising a pair of spade connectors coupled to second ends of said twisted wire pair and configured for connecting to conventional screw terminals.

10. A network interface device as in claim 8, further comprising a pair of spade connectors coupled to second ends of said twisted wire pair and configured for connecting to conventional screw terminals.
